(19) United States
(12) Patent Application Publication
(10) Pub. No.: US 2008/0083847 A1
(43) Pub. Date: Apr. 10, 2008

(54) Air Locomotion Method and Multi-Purpose Aircraft Having Inflatable Wings(S) Using Two Different Inflating Systems

(76) Inventor: Phiran Mau, Marseille (FR)

Correspondence Address: EGBERT LAW OFFICES, 412 MAIN STREET, 7TH FLOOR, HOUSTON, TX, 77002, US

(21) Appl. No.: 11/813,584

(22) PCT Filed: Jan. 18, 2006
(86) PCT No.: PCT/FR06/00110

§ 371 Date: Aug. 21, 2007

(30) Foreign Application Priority Data
Jan. 20, 2005 (FR) 0500588

(51) Int. Cl. B64C 31/036; B64C 3/46; B64D 17/02

(52) U.S. Cl. 244/13; 244/902; 244/903

(57) ABSTRACT

The invention relates to a multi-purpose aircraft including at least one cockpit equipped with at least one motor-driven propeller capable of ensuring the displacement of this aircraft through the air and at least one flexible wing having an upper cloth or a flexible wall of the upper wing surface and a lower cloth or a flexible wall of the underwing defining an inflatable volume. When deployed, a leading edge and a trailing edge are defined for two different inflating systems. The aircraft includes a device or an arrangement enabling the insufflation of pressurized gas into the inflatable volume of the wing and air inlet openings distributed along the leading edge of the wing. The opening lead into the inflatable volume thereof for enabling the admission of air into the inflatable volume when in flight.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

This invention concerns an air locomotion method. It also relates to a multi-purpose aircraft having inflatable wing(s) of the aerodyne or aerostat type, constituting a new air carrier capable of combining the flying characteristics of an airplane, glider, helicopter, ULM (ultralight/microlight aircraft) or paraglide.

2. Description of Related Art

Including Information Disclosed Under 37 CFR 1.97 and 37 CFR 1.98.

The above-mentioned devices each have special advantages in their flying technique, but also disadvantages specific to each one.

For example:

An airplane is very costly. It allows for high speed travel over long distances and with a significant carrying capacity; however, it does not offer (at least in the areas of civil applications) the capability of vertical take-off/landing, or of hovering. It requires a high power consumption and a very costly servicing/maintenance program; the pilots must be highly experienced and accidents are almost always deadly.

The helicopter offers the capability of vertical take-off/landing and of hovering; however, this is also an aircraft whose purchase and use involve very high costs, with a small carrying capacity in relation to the power used and that can be flown only by highly experienced pilots. In addition, helicopter accidents are also almost always deadly.

The paraglider is a light aircraft with a low cost price and very economical since it uses the natural energy of wind to fly. In addition, it is relatively easy to fly and presents a low fatality risk in case of accidents; however, the flying capability is contingent on the aerological, climatic and geographic conditions, the flying speed is very limited, the aircraft carrying capacity is very restricted and it practically cannot be remote-controlled.

The paramotor or carriage paramotor, a class 1 ULM, has the advantages of the paraglider (light, compact, low cost, easy to pilot) as it flies with a paraglider wing, with the additional advantage of being able to take off from a flat land due to the motorization. However, it also retains its disadvantages, especially the gliding school training, the flying aerological conditions and the always existing risks that the wing closes, but mainly the great difficulty in achieving an easy take-off because of the weight of the motor to carry on the shoulders, which has to be managed in addition to the take-off itself (in the case of a paramotor), or the difficulty in raising the wing properly above the chassis (in the case of a carriage paramotor).

The class 2 pendular ULM constitutes an aircraft with a safety/piloting/price compromise, probably the most interesting to date. The piloting, while remaining delicate, is somewhat simpler than with a multi-axis, but landing always remains very tricky and the risk of serious accidents remains high in case of engine failure.

### BRIEF SUMMARY OF THE INVENTION

This invention proposes to make a new motorized aircraft, permitting to combine, in one single machine, the advantages of the five types of aircrafts mentioned above, while avoiding their respective disadvantages.

In U.S. Pat. No. 5,620,153, a flying machine is proposed, of the ULM type, consisting of an inflatable wing connected through suspension lines to a motorized cockpit. Several inflation methods are proposed for the inflatable wing to replace the conventional inflation system using air inlet openings distributed along the leading edge of the wing and possibly equipped with check valves. For example, it is proposed to inflate the wing:
using a non-carrier gas (compressed air, for example) or a carrier gas (helium or hydrogen) blown into the volume of the inflatable wing via ports equipped with inflation valves placed close to the wing trailing edge, or
using exhaust gases produced by the combustion engine of the aircraft and led to the wing inflatable volume through a supply line ending into said volume, or
using at least part of the gaseous fluid stream blown by the propeller equipping the aircraft.

According to U.S. Pat. No. 5,620,153, the various inflation systems described can be implemented only separately so that they each offer more or less interesting advantages and more or less severe disadvantages. For example, none of these inflation systems provides actual safety when in flight.

A first objective of the invention is to eliminate this disadvantage.

Under the invention, this goal is achieved using a method applicable to a multi-purpose aircraft comprising, on one hand, a cockpit equipped with at least one motor-driven propeller capable of ensuring the displacement of this aircraft through the air and, on the other hand, at least one inflatable flexible wing, comprising an upper cloth or flexible wall of the upper wing surface and a lower cloth or flexible wall of the underwing delimiting an inflatable volume and defining, when deployed, a front edge or leading edge and a back edge or trailing edge. This method is characterized in that the inflatable wing is inflated and kept inflated through the functioning, concurrently or successively, of two different inflation systems. A first inflation system uses a device or arrangement enabling the insufflation of a pressurized gas into the entire or only a portion of the inflatable volume of the wing. A second inflation system uses the admission of air into the entire or only a portion of the inflatable volume of the wing, when in flight.

The multi-purpose aircraft to which the invention applies is of the type comprising, on one hand, a cockpit equipped with at least one motor-driven propeller capable of ensuring the displacement of this aircraft through the air and, on the other hand, at least one inflatable flexible wing, comprising an upper cloth or flexible wall of the upper wing surface and a lower cloth or flexible wall of the underwing delimiting together an inflatable volume and defining, when deployed, a leading edge and a trailing edge. The aircraft is noteworthy in that it is designed so as to allow for the functioning, concurrently or successively, of two separate inflation systems The aircraft comprises, to that end, on one hand, a device or arrangement enabling the insufflation of a pressurized gas into the entire or only a portion of the inflatable volume of the wing, and, on the other hand, air inlet openings distributed along the leading edge of the wing and ending into the inflatable volume of the latter to enable admission of air into the entire or only a portion of the inflatable volume when in flight, whenever the inside pressure in the inflatable volume of the wing is lower than the outside pressure.

According to an interesting implementation of the method and of the multi-purpose aircraft under the invention, the pressurized gas is blown or inflation air is admitted into the entire inflatable volume of the wing and the air inlet openings are equipped with check valves.

According to another advantageous embodiment, an intermediate cloth or intermediate flexible wall is placed between the flexible wall of the upper wing surface and the flexible wall of the underwing, so that the total inflatable volume consists of two superposed inflation chambers with variable capacity. A first inflation chamber into which run the air inlet openings is provided along the leading edge of the wing and equipped or not with a check valve. A second inflation chamber is preferably placed under the first chamber, into which the pressurized gas inlet line runs.

According to an interesting embodiment, the motor-driven propeller equipping the aircraft under the invention consists of a propeller driven in rotation by a heat engine, electric engine, turboshaft engine, turboprop engine, jet engine or turbojet engine. The propeller functioning generates a gaseous fluid stream or flow, and said aircraft comprises an arrangement enabling to recover and to blow at least part of the stream or flow of gaseous fluid blown by said propeller, inside the inflatable wing, so as to inflate and, optionally, keep inflated the latter when in flight.

According to another embodiment, the aircraft is equipped or designed to be equipped with a pressurized gas (compressed air, nitrogen, helium, hydrogen, etc.) cylinder or tank permitting to inflate the inflation volume or the second inflation chamber of the inflatable wing.

According to their possible implementations and embodiments, the method and the multi-purpose aircraft under the invention provide several interesting advantages such as, for example:
high safety when in flight and in case of forced landing; in case of emergency landing, the flexible wing inflatable through air admission acts as an emergency parachute; easy take-off: it is no longer necessary to run to inflate the wing, nor to have wind present, as is the case for the conventional paragliders; in other words it is not mandatory to take off from a hillside or slope to gain speed, inflate the wing and generate a lift force; the pressurized gas or gaseous fluid flow generated by the motor-driven propeller can indeed fulfill that function and therefore permit take-off on flat land, without any requirement to be up high;
possible construction in the form of a light aircraft that is stable when in flight;
very small ground area required due to the use of flexible and light wing(s) that can be folded up or compacted;
easy piloting;
possibility to use natural wind and upward air currents to increase the flying capacity of the aircraft and reduce fuel consumption; it is indeed possible to stop the running of the motor-driven propeller in the presence of sufficiently strong wind to fly the aircraft in a standalone manner, resulting in a very economical operation and greater flight autonomy;
market launching of a new means of transportation at a highly reduced cost compared to helicopters and airplanes;
very low fabrication cost resulting especially from reduced technical stresses compared to the construction of the current rigid airplane wings;
capability of carrying heavy loads; and
remote control capability.

According to another important peculiarity of the invention, the inflatable flexible wing or each inflatable flexible wing is connected to the cockpit, for example to the fuselage of the aircraft, on one hand, through at least one rigid spacing member, for example consisting of a tubular column or of a rigid mast, and, on the other hand through flexible holding elements, for example of the suspension line and riser type. The rigid mast is connected to the chassis or to the fuselage of said aircraft through an articulation enabling the rigid mast to pivot from the front to the back and vice-versa, with preferably adjustable stops limiting the amplitude of such pivoting.

Advantageously, the rigid spacing member has a limited amplitude variable length. More specifically, the rigid spacing member is attached to the wing through means permitting a limited amplitude movement of said wing in relation to the top of said rigid spacing member and parallel to the axis of the latter.

Using these arrangements, the wing is capable of moving freely, especially in the vertical direction in relation to the cockpit of the aircraft, the amplitude of such movement being limited.

This limited movement capability of the flexible wing in relation to the cockpit makes it possible to achieve optimum operation of said flexible wing. When in flight, the function of both types of attaching elements (rigid mast and flexible suspension lines and risers) is to receive and distribute the tractive forces associated with the weight of the cockpit to be borne by the wing. These two types of attaching elements operate in a synergistic and complementary manner. The suspension lines are indeed attached and distributed over the whole surface of the underwing and thus permit to advantageously distribute the tractive forces over the whole surface of the underside of said wing.

According to another interesting characteristic arrangement of the invention, the inflatable volume or inflatable chamber of the wing is inflated using at least part of a downward air stream or flow generated by a motor-driven propeller installed in the center section of said inflatable wing.

Using this arrangement, the air stream or flow generated by the propeller permits both inflation of the wing and vertical displacement of the aircraft that is thus provided with a vertical take-off and landing capability.

### BRIEF DESCRIPTION OF THE SEVERAL VIEWS OF THE DRAWINGS

The above purposes, characteristics and advantages and many more will become clearer from the description below and the attached drawings.

FIG. 1 is a schematic front view of a first example of aircraft under the invention, made in the form of a self-supporting inflatable flying wing.

FIG. 2 is a perspective view of a second example of aircraft made in the form of a self-supporting inflatable flying wing.

FIG. 3 is a schematic front view of another example of embodiment of the aircraft under the invention, made in the form of an airplane or ULM.

FIG. 4 is a perspective view of this example of embodiment.

FIG. 5 is a cross sectional schematic view along line 5-5 from FIG. 6, showing an embodiment under which the wing comprises a single inflation volume.

FIGS. 6 and 7 are sectional views, respectively, showing the inflation of the wing using a pressurized gaseous fluid prior to the take-off phase and flight phase.

FIG. 8 is a sectional view, showing the inflation of the wing through admission of air, when in gliding flight.

FIG. 9 is a sectional schematic view along line 9-9 from FIG. 8, showing an embodiment under which the wing comprises two superposed inflation volumes.

FIG. 10 is a partial top plan view of this wing middle section.

FIG. 11 is a sectional view along line 11-11 from FIG. 10.

FIGS. 12 and 13 are sectional views, respectively, showing the inflation of the wing lower inflation chamber, using a gaseous fluid stream or flow generated by the aircraft motor-driven propeller prior to the take-off phase and to the flight phase.

FIG. 14 is a schematic view of the arrangement permitting guidance of aircrafts with inflatable wings during flight.

FIG. 15 is a schematic view of an embodiment of the system enabling the wing to move freely in vertical direction in relation to the cockpit, and of the device limiting the amplitude of such movement.

FIG. 16 is a detail perspective schematic view, showing an example of construction of the inflatable wing structural members.

### DETAILED DESCRIPTION OF THE INVENTION

Reference is made to said drawings to describe interesting, although not limiting, examples of implementation of the air locomotion method and construction of the aircraft under the invention.

In the description below, it should be noted that the terms “transverse” and “transversely” designate a direction connecting the leading edge and the trailing edge of the claimed aircraft wing.

The aircrafts to which the invention is applicable have at least one cockpit 1, one inflatable flexible wing 2 usually placed above and away from said cockpit and a propelling device or motor-driven propeller 3 capable of ensuring the displacement of said aircrafts through the air.

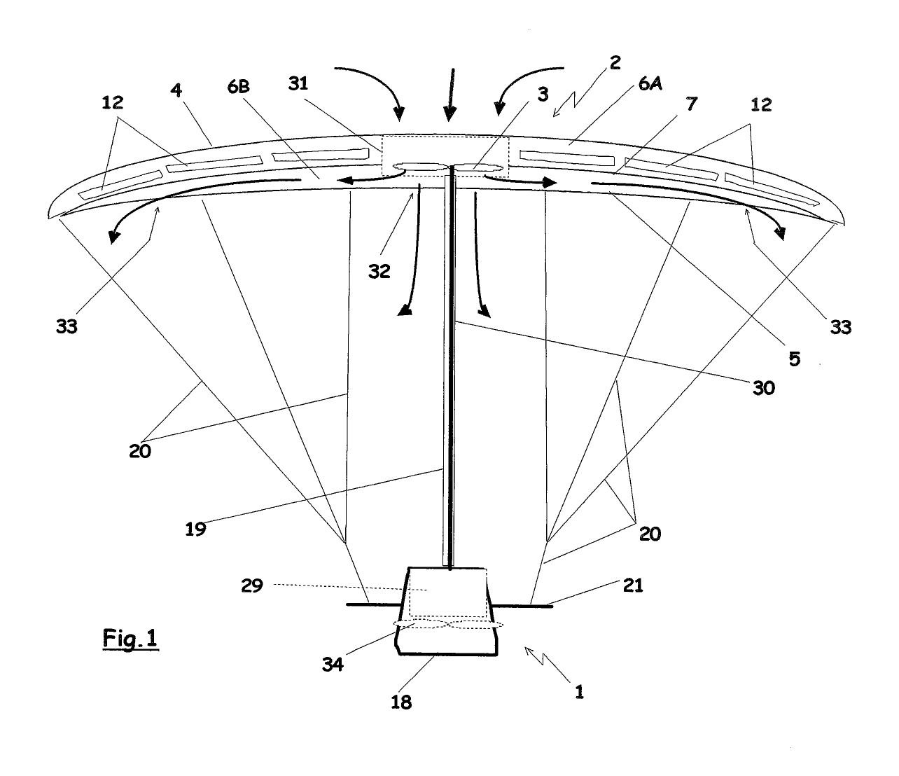

Such aircrafts are shown as examples only in FIGS. 1, 2, 3, and 4

The other components (structural members, control and steering components, etc.) are specific to the type of machine in question (motor-driven flying wing, airplane, helicopter, etc.).

The contoured inflatable wing 2 is overall comparable to a paraglider wing. It can be made of a light airtight and highly resistant fabric such as a polyester fabric, a polyamide fabric, spinnaker cloth, etc.

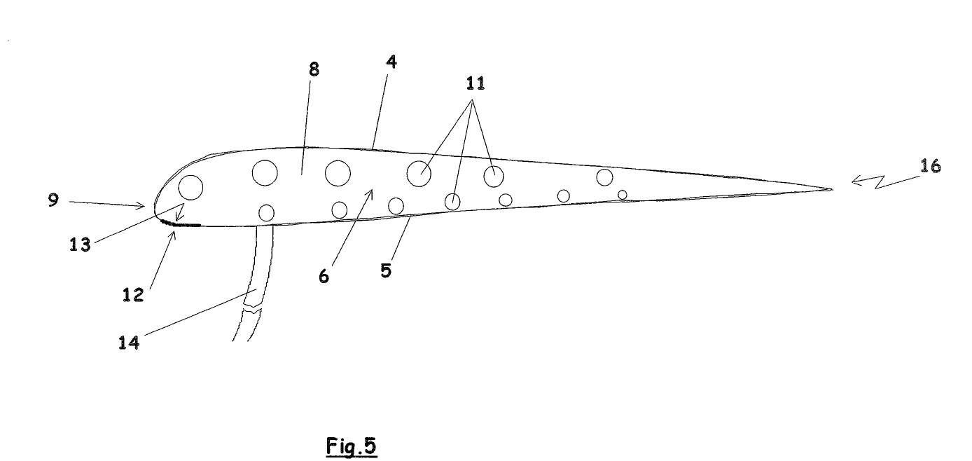

It can consist of two superposes flexible cloths assembled along their edges, i.e., an upper cloth or a flexible wall of the upper wing surface 4 and a lower cloth or a flexible wall of the underwing 5 delimiting, together, a closed inflation volume 6 (FIGS. 5 through 7) and defining, when deployed, a leading edge 9 and a trailing edge 16.

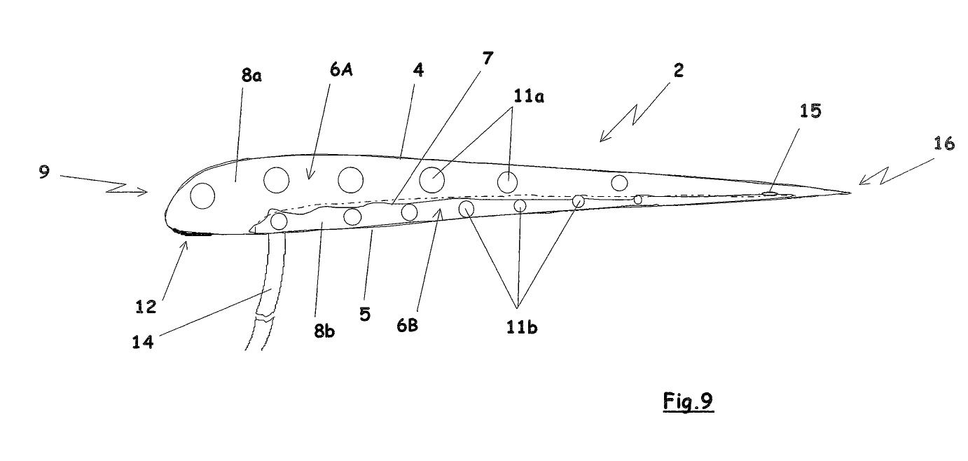

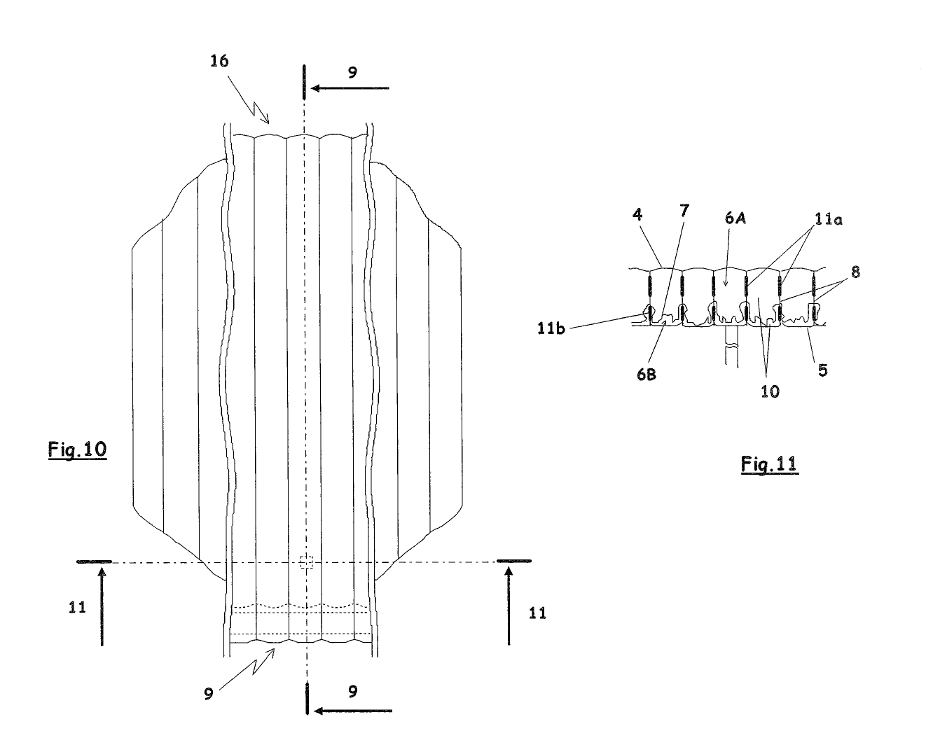

According to an advantageous embodiment, the inflatable wing 2 can comprise a separating cloth or wall 7 arranged between the walls of the upper wing surface 4 and of the underwing 5, so as to delimit, between the latter, a first upper inflation chamber 6A and a second lower inflation chamber 6B, as shown, for example, in FIGS. 1 and 9 through 13.

The inflation volume 6 or the superposed inflation chambers 6A, 6B are partitioned by flexible transverse separating elements 8 or 8a, 8b, i.e., elements oriented perpendicular or roughly perpendicular to the leading edge 9 of the inflatable wing so as to form multiple juxtaposed inflatable box structures 10 inside said wing. These inside partitioning elements have a shape designed so that the upper cloth 4 gives a contoured shape to the inflatable wing, in its upper wing surface portion. They are provided with ports 11, 11a, 11b, permitting communication between one another and circulation of the gaseous fluids between said boxes.

According to the method under the invention, the wing is inflated and, optionally, kept inflated through the functioning, concurrently or successively, of two separate inflating systems, i.e., a first inflating system using a device or arrangement enabling the insufflation of a pressurized gas into the entire or only a portion of the inflatable volume of the wing, and, a second inflating system using admission of air, when in flight, into the entire or only a portion of the inflatable volume, through air inlet openings 12, provided along the leading edge 9 of the wing and ending into the inflatable volume 6 or 6A of said wing.

The multi-purpose aircraft under the invention is designed to allow for the functioning, concurrently or successively, of two separate inflating systems, the aircraft comprising to that end, on one hand, a device or arrangement enabling the insufflation of a pressurized gas into the entire or only a portion of the inflatable volume of the wing, and, on the other hand, air inlet openings 12 distributed along the leading edge 9 of the wing 2 and ending into the inflatable volume of the latter to enable admission of air into the entire or only a portion of the inflatable volume when in flight,

According to the embodiment shown in FIGS. 5 through 10, the inflatable wing comprises a single inflation volume 6 delimited by the walls of the upper wing surface 4 and underwing 5. In this case, the air inlet openings are equipped with check valves 13.

A supply line 14 runs into the center section of the inflatable volume 6 and, preferably at a reduced distance from the leading edge 9, permitting to introduce pressurized gas into said volume.

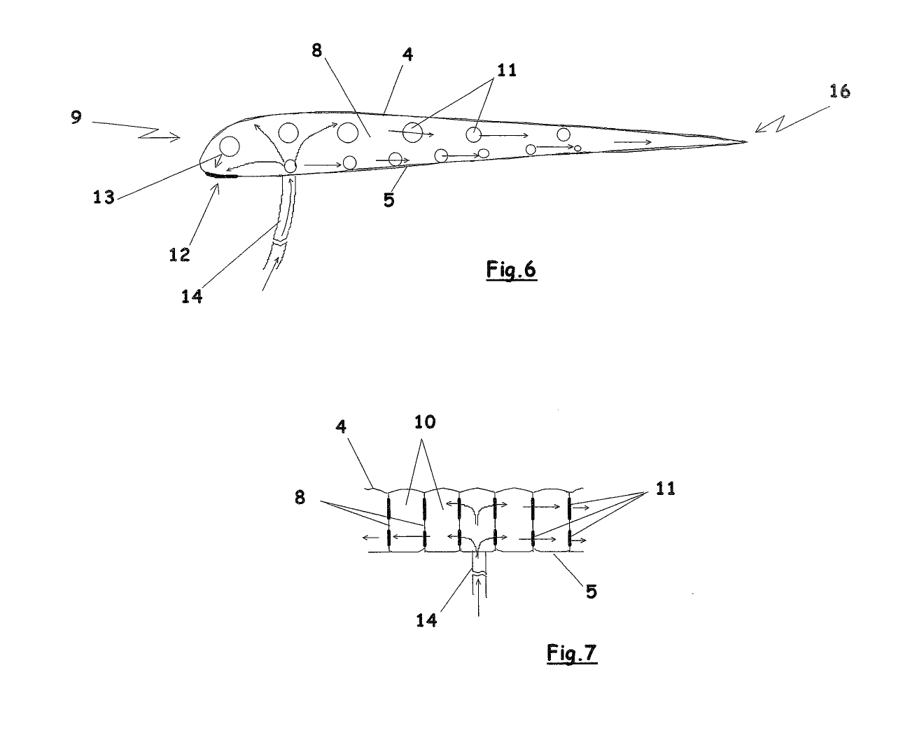

FIGS. 6 and 7 show the inflation of the wing prior to take-off. The pressurized inflation gas is blown and distributed into the volume 6 (according to the arrows on FIGS. 6 and 7) of the wing 2, until said wing has the desirable rigidity to allow for take-off. During inflation, the air inlet openings 12 are plugged by the check valves 13, so as to prevent release of the gas introduced into the volume 6.

This configuration also enables flying when the pressurized gaseous fluid generating device or arrangement permits to introduce the desirable quantity of gas into the inflation volume, at all times, based on needs. In this case, the check valves 13:
prevent the gas contained in the inflatable volume 6 from escaping through the openings 12; and
let air enter into said volume when it's inside pressure allows it.

FIG. 8 shows the inflation of the wing through admission of air into the volume 6, when in gliding flight. In this case, the check valves 13 are opened under the action of the wind force or the flying speed and let air enter through the openings 12, while the introduction of pressurized gas into said volume is stopped.

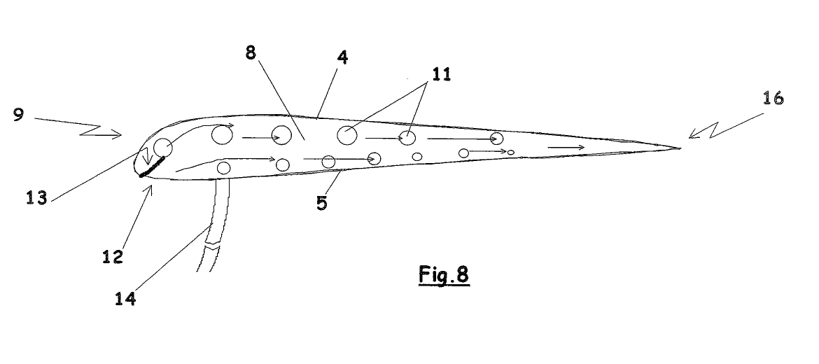

According to the embodiment shown in FIGS. 9 through 13, the inflatable wing 2 comprises two superposed inflation chambers, i.e., a first upper chamber 6A delimited by the wall of the upper wing surface 4 and the flexible separating wall 7 and a second lower chamber 6B delimited by the wall of the underwing 5 and by said separating wall 7.

According to the embodiment shown as example, the supply line 14 permitting to introduce the pressurized gas into the inflatable wing 2 runs into the lower chamber 6B, and into the center section of said wing, preferably at a reduced distance from the leading edge 9 of said wing.

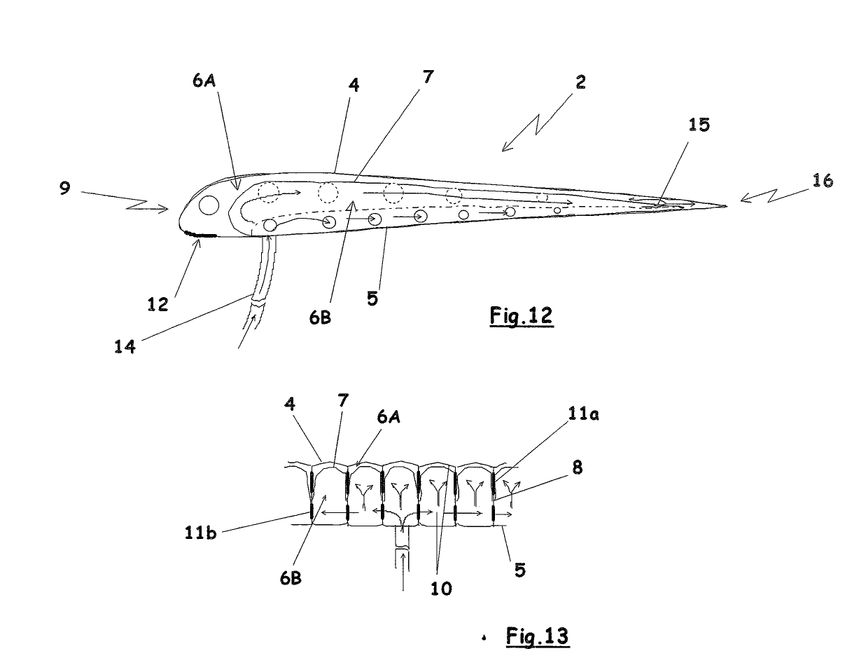

FIGS. 12 and 13 show the inflation of the lower chamber 6B of the wing 2 prior to take-off. The pressurized inflation gas is blown and distributed into the lower chamber 6B (according to the arrows) until the wing 2 has the desirable rigidity to allow for take-off. During this inflation phase, the lower chamber 6B may occupy all or substantially all of the overall volume delimited by the flexible walls of the upper wing 4 and underwing 5 because of the flexibility of the separating wall 7.

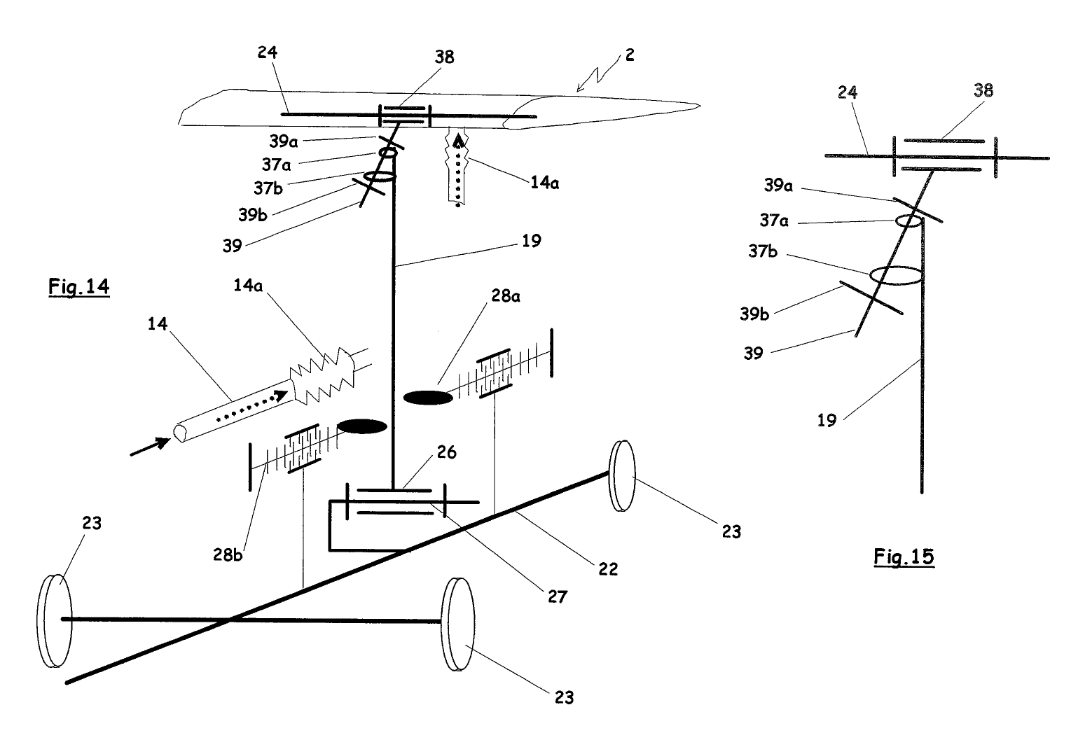

Outlet ports 15 enabling communication between the chambers 6A and 6B can be provided in the separating wall 7, close to the trailing edge 16 of the wing 2 (FIG. 14). These ports also permit to introduce into the chamber 6A, at least part of the gaseous fluid blown into the chamber 6B. Such arrangement permits to further enhance the inflating capabilities of the chamber 6A, with the inflation gaseous fluid (in addition to the air generated by the wind or by the flying speed that enters through the openings 12 on the leading edge) permitting to increase the wing 2 inflation performances. Due to the presence of the communication ports 15, the synergy is also increased in the functioning of the two inflating systems of the wing. During the take-off preparation phase, the air inlet openings 12 are plugged by the check valves 13.

FIG. 17 shows the wing 2 when in flight, as the two inflating systems are functioning concurrently, these two systems completing each other and working synergistically while inflating the entire inflation volume of the wing delimited by the cloths of the upper wing 4 and underwing 5.

It should be noted that in the case when the inflatable wing 2 comprises two inflation chambers 6A and 6B, it is possible not to equip it with check valves 13 on the air let openings 12, which permits to make the fabrication of said wing significantly easier, while preserving its proper inflating operation. The presence of the separating wall 7 permits indeed to ensure that the chamber 6B is sufficiently pressurized and deployed without having to use the check valves 13 to maintain the inside pressure of the wing. In a way, the separating wall 7 can compensate for the ‘absence of the check valves 13.

Both embodiments of the invention described above are more specifically intended for aircrafts whose transverse displacements are provided by a motor-driven propeller, for example consisting of a propeller, driven in rotation by a heat engine, or by an electric engine, or by a turboshaft engine, or by a turboprop engine, or by a jet engine, or by a turbojet engine, whose functioning generates a gaseous fluid stream or flow, blown by said propeller inside the volume 6 or the inflation chamber 6B of the wing, so as to inflate and keep inflated the latter when in flight.

In this situation, the pressurized gas contained in the lower chamber 6B keeps it inflated while the check valves 13 are opened under the action of the wind force and/or flying speed and let air enter into the upper chamber 6A through the openings 12 distributed along the leading edge 9 of the wing.

The two inflating systems permit to inflate the entire inflation volume of the wing, including the chambers 6A and 6B, these two systems completing each other and working in synergy.

Furthermore, as for the embodiment shown in FIGS. 9 through 13, the inflation of the wing 2 by the relative airflow that enters into the air inlet openings 12 constitutes a critical safety when in flight; it permits to inflate all or substantially all of the wing volume delimited by the cloths of the upper wing surface 4 and underwing 5, in case the chamber 6B should deflate or not be able to be kept inflated, for example due to a puncture of the underwing cloth.

The flexible and light inflatable wing under the invention is attached to a rigid element of the cockpit, preferably to the fuselage 18 of the aircraft through at least one rigid spacing member 19, for example consisting of a tubular column or of a rigid mast, and through multiple flexible holding elements 20 of the suspension line or riser type. These attaching elements have a length permitting to have a sufficient distance between the cockpit 1 and the inflatable wing 2.

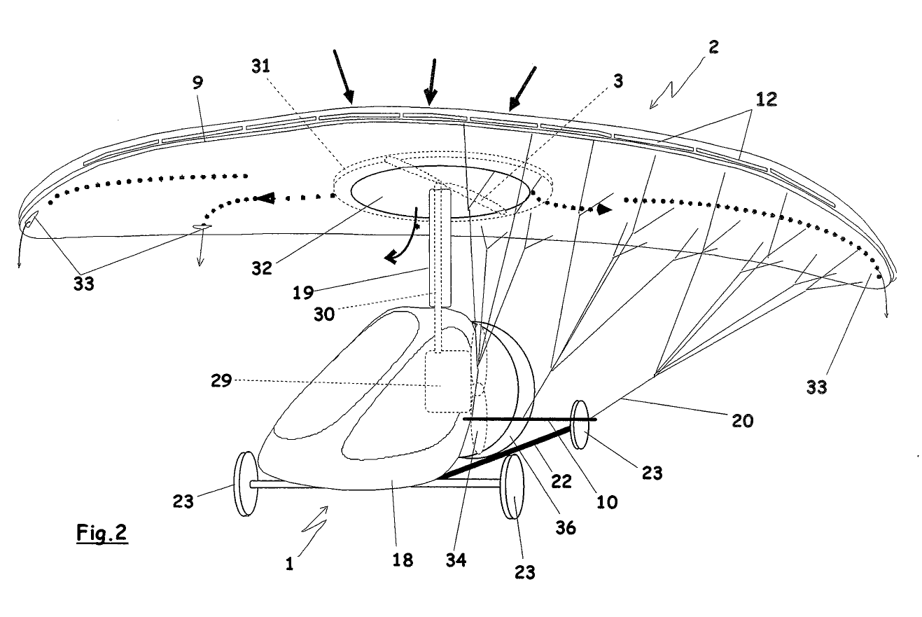

The flying wing has at least one attachment shaft 21, fixed to the cockpit (fuselage or other) to receive the suspension lines and risers 20. The cockpit 1, for example installed in a fuselage 18 can be mounted on a chassis 22 equipped with wheels 23 (FIG. 2).

In addition, structural members 24 and 25 for example made out of light alloy or composite materials can be fixed to the upper part of the support column 19 and are installed in the closed inflation volume 6 of the wing, especially when said wing comprises one single inflation volume.

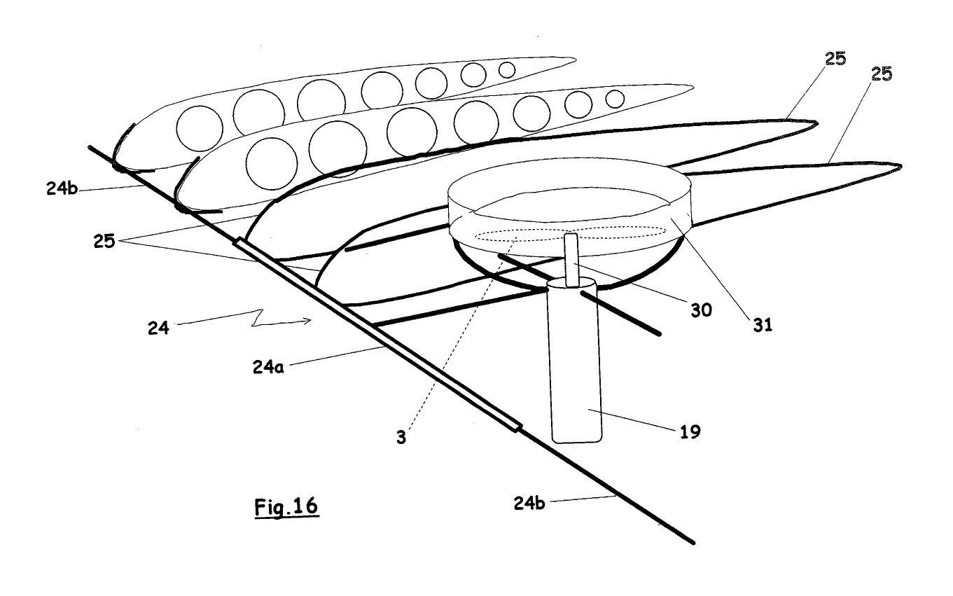

One of the functions of these structural members 24 and 25 (FIG. 16) is to give a semi-rigid structure to the inflatable wing, enabling said wing to face flying conditions much more difficult than those that can be withstood by the wings of conventional paragliders, while avoiding closing risks. This way, the wing can function under flying conditions close to those of airplanes, including under strong wind and rainy weather.

Moreover, the function of some of the structural members (structural members 25) is also to give the shape of a contoured wing to the inflation volume 6, in the center section of the wing, which will:
facilitate the inflation of the entire closed inflation volume by guiding the movement of the flow of air or other gaseous fluid, and
contribute to the holding of the contoured shape of the wing 2 overall, including in its flexible sections, especially the areas close to its edge that tend to easily get out of shape when in turbulent flight.

These structural members 24, 25 are primarily located in the center section of the wing 2. One of these members consisting of a spar 24 can be placed longitudinally at the leading edge 9 of the wing over a significant length, while other structural members consisting of trusses 25 have the shape of an airplane wing section and are oriented transversely, from the leading edge 9 to the trailing edge of the inflatable wing. These framing members 25 are fixed to the upper 4 and lower 5 cloths, respectively.

It should be noted that the function of the structural members 24 and 25 includes to give a semi-rigid structure to the inflatable wing, and that they thus enable the inflatable wing 2 to work more efficiently in compression due to the presence of the rigid support spacing member 19 that fixes it the cockpit 1, preferably to the aircraft fuselage 18. The retractable spar 24 is positioned longitudinally and located close to the leading edge 9. Therefore, the retractable spar 24 permits to compact the wing from its lateral ends to its center lengthwise. Finally, the structural members 25 of this invention have an airplane contoured shape and are installed only in the center section of the wing 2, thus offering the contoured shape of the wing 2 in its middle when not inflated, facilitating also the inflation of the entire closed inflation volume by guiding the movement of the flow of air or other gaseous fluid, while contributing to the keeping of the contoured shape by the wing assembly 2, including its flexible section, and mainly enabling the inflatable wing 2 to work more efficiently in compression due to the presence of the rigid support spacing member 19.

The spar 24 located at the wing leading edge can consist of three rigid sections, i.e., a tubular center section 24a and two end sections 24b mounted with axial sliding capability in the center section. The spar 24 has a variable length. This arrangement permits, on one hand, when in flight, to have available a spar of significant length, facilitating the keeping under any circumstances of the deployed shape of the inflatable wing, and, on the other hand, to permit better compacting of the inflatable wing and to minimize the space it occupies when not used.

However, for wings with smaller span and to simplify the fabrication and application of the method, the spar 24 can be made of one single piece, with a length less significant but sufficient to perform the functions of rigidizing the wing 2 and keeping it deployed, when in flight.

Piloting the aircraft can be carried out through the combination of the following two actions:
change the plane of inclination of the wing 2, by modifying the angular position of the rigid support spacing member 19 of said wing in relation to the vertical; and
modify the shape of the wing 2, by acting on the leading and trailing edges of said wing through the suspension lines 20, like on a conventional paraglider wing.

The change of plane of inclination of the wing 2 enabling the piloting of the aircraft can be achieved by a device such as schematically shown in FIG. 24. According to the embodiment shown, the rigid support spacing member 19 of the wing 2 is connected to the chassis 22 of the machine, via the fuselage 18, through a pivot type articulation 26 enabling it to pivot from the front to the back and vice versa, above said fuselage and lengthwise in relation to the latter. The axis 27 of this pivot type articulation is parallel to the ground (when the aircraft is stopped) and perpendicular to the fuselage of the aircraft.

Furthermore, the lower section of the rigid support spacing member 19 is arranged between two stops 28a, 28b, judiciously placed in the front and back of said member, respectively, to limit the maximum amplitude of the possible slew angle of said member around its articulation axis 27. The positions of these two stops 28a, 28b can be adjusted by well-known suitable mechanical means so that it is possible to freely control the maximum amplitude of the allowable pivoting angle to be made by the rigid support spacing member 19, as well as the position of the pivoting angle in relation to the vertical.

It is understood that giving to the rigid support spacing member 19 the capability of pivoting from the front to the back means giving to the wing 2 the capability of also swinging from the front to the back, resulting in the variation of the angle of inclination of the plane of the wing 2 in relation to the horizontal, a capability that can be used in the aircraft piloting process.

According to a highly advantageous embodiment of the invention, at least part of the gas stream or flow generated by the operation of the propelling device or motor-driven propeller 3, is blown inside the inflatable wing 2, to inflate the wing and keep it inflated.

Two different types of embodiments of the aircraft with inflatable wing(s) under the invention can be identified depending on the direction and inlet path of the blast of gas into the closed volume 6 or the chamber 6B of the wing 2, namely:
a first embodiment under which the slipstream of gaseous fluid has a downward vertical path and enters from the top into the closed inflation volume 6 or into the chamber 6B of the inflatable wing 2 through an opening provided in the upper cloth or wall of the upper wing surface 4 of said wing, and, if applicable, through a subjacent opening provided in the flexible separating wall 7; and
a second embodiment under which the slipstream of gaseous fluid has an upward vertical path and enters from the bottom into the closed inflation volume 6 or into the chamber 6B of the inflatable wing 2 through an opening provided in the lower cloth or wall of the underwing 5 of said inflatable wing.

It is understood that the surface area of the wing 2, the resistance rating and the strength of the cloth the wing is made of, the power of the motor-driven propeller 3 are determined based on the total weight to be air-carried.

Examples of construction based on the two types of embodiments mentioned above are described below.

According to the example shown in FIG. 1, the propelling device 3 consists of a propeller driven in rotation by an engine 29, for example a heat engine, installed on the cockpit 1, for example on fuselage 18, and coupled to said propeller through a drive shaft 30. Said shaft can advantageously be housed in the support column 19 so as to avoid that the rotating element consisting of said drive shaft 30 cannot come into contact with the outside environment during operation.

The propeller 3 is housed axially in a rigid tubular suction port 31 arranged in the center section of the inflatable wing 2 and running through superposed openings provided in the upper cloth 4 and the separating flexible cloth 7. This tubular port ends into the lower inflation chamber 6B of the wing 2, and its function is to allow air circulation downward through the walls 4 and 7 of the wing. It is attached to the top of the support spacing member 19 and to the cloths 4 and 7.

During take-off or hovering, the propeller or rotor 3 is positioned horizontally or approximately horizontally like the main rotor of a conventional helicopter.

The motor-driven propeller 3 performs two functions simultaneously:
it creates a lift force causing an ascending movement of the machine similar to that of an helicopter; and
it constitutes a source of generation of an air stream or flow used to inflate the inflation chamber 6B of the inflatable wing 2, delimited by the separating cloth 7 and the lower cloth 5; the air blast produced by the rotation of the propeller is led into the inflation chamber 6B and when entering in said chamber, it ensures the wing inflation and gives it its desired airplane wing shape.

The major part of the air blast generated by the rotation of the propeller 3 housed in the wing 2 is discharged directly toward the bottom through an opening 32 provided in the center section of the lower cloth 5, below said propeller and whose diameter corresponds for example approximately to the diameter of the surface area made up by the propeller blades, being preferably slightly smaller than the latter.

Advantageously, this central opening 32 can be equipped with a device (not shown) enabling its partial or full closure. This device can consist of a retractable flexible flap or cloth installed on the lower cloth 5, close to the opening 32. The function of this device is to permit to cover or close temporarily said opening in the specific case where the aircraft is in gliding flight with the motorization off. In this situation, the advantage of the closing of the central opening 32 using a retractable flap is to increase the total effective area of the upper wing 5 cloth and the lift force of the wing 2 and, therefore, to improve the performance of the latter accordingly.

The retractable flexible flap can be operated by the aircraft pilot, for example, using a control cable.

Before restarting the motor-driven propeller 3-29, the pilot operates the retractable flap so as to bring it back to its initial retracted condition before opening the opening 32 located below the propeller 3 so that said opening can perform its function whenever the motor-driven propeller 3-29 is operating.

The other part of the air blast generated by the rotation of the propeller is blown into the inflation chamber 6B of the wing 2. The part of the air stream (shown by the arrows on FIGS. 14 through 17) that flowed through the inflation chamber 6B of the wing 2, is then released through outlet ports 33 judiciously provided in the lower cloth 5 of the wing 2, for example close to the trailing edge and ends of said wing (FIG. 2). In addition to the air releasing function, some ports 33 can also be used to discharge the rainwater that might have entered into the wing 2, during flight.

It is noted that the air used to inflate the wing 2 is then expelled at the lower surface of said wing through the outlet ports 33, which generates a thrust power that facilitates the ascending movement of the aircraft in synergy with the air suction process at the upper surface of the wing.

In addition, in order to create an additional horizontal thrust power, it is planned to mount a second motor-driven propeller 34 or a jet engine, capable of effecting the translation displacement of the aircraft at the fuselage 18. This second motor-driven propeller 34 can be installed in the front of the fuselage 18 (FIG. 29) or behind said fuselage (FIG. 2).

According to this embodiment, it is understood that due to the configuration of the aircraft in the form of a self-supporting inflatable wing, part of the air blast generated by the motor-driven propeller 3-29 is used to inflate the contoured wing. Thus, the aircraft under the invention can be compared to a helicopter equipped with a very light airplane wing: it thus combines the advantages of an helicopter and an airplane. However, it reduces significantly the disadvantages of these two types of aircrafts due to the very light weight of its inflatable wing 2, its much simpler and safer operation and its flying technique comparable to that of a conventional paraglider and with much easier approach.

Moreover, it is preferable to apply this embodiment to aircrafts containing a wing 2 comprising two superposed inflation chambers 6A and 6B capable of being inflated using two inflation systems, concurrently or not, in order to achieve optimum efficiency in the wing operation. However, for reasons of simplification and easy fabrication, the aircraft can also be designed with a wing equipped with one single inflation volume 6, and provided with well-known check valves 13, installed on the air inlet openings 12 distributed along the leading edge 9.

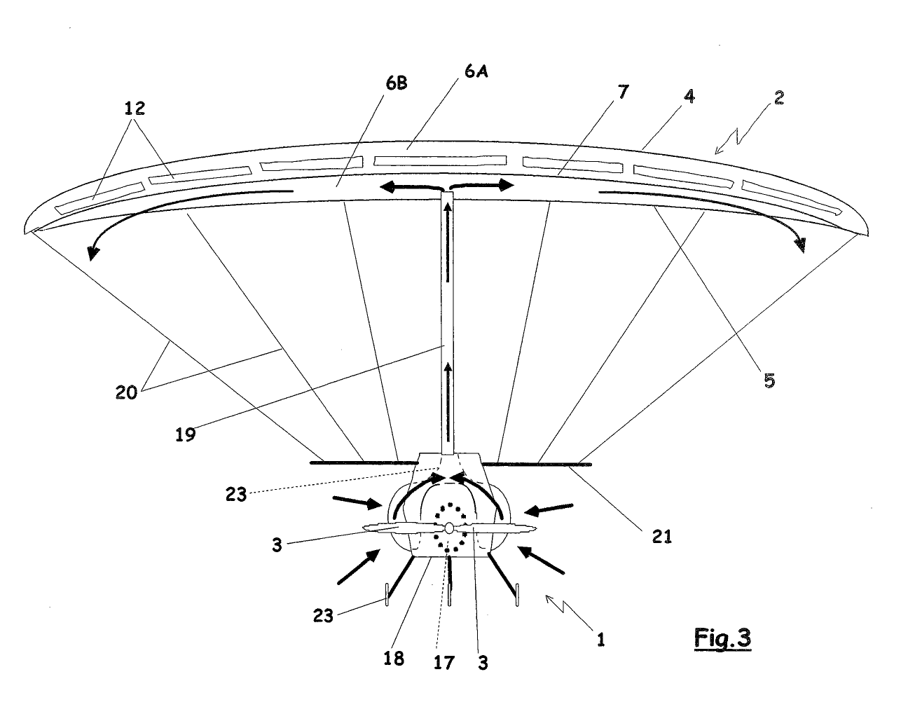

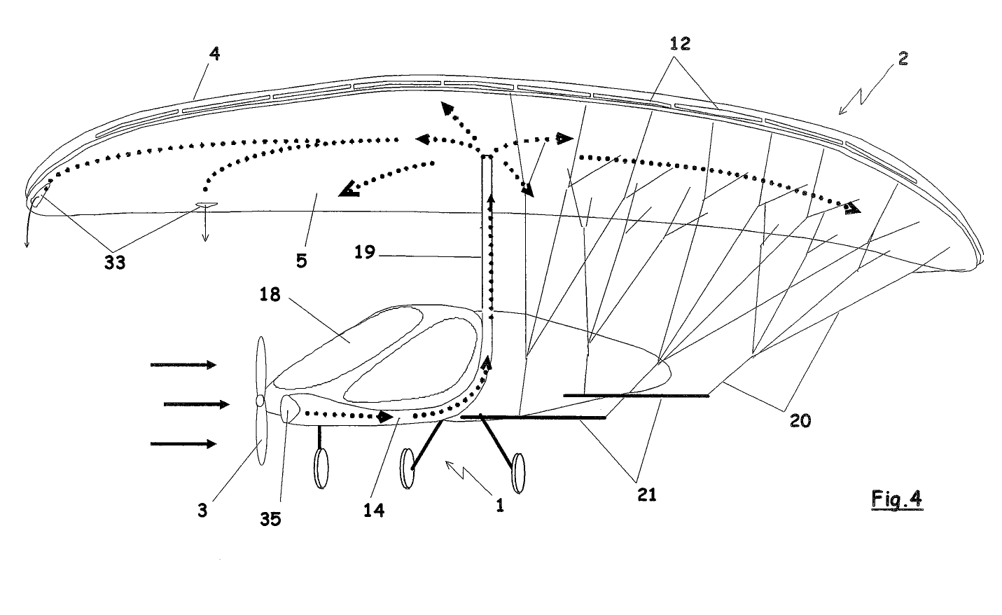

FIGS. 3 and 4 show an embodiment of the aircraft under the invention in the form of an airplane with inflatable wing, under which the gaseous fluid flow blown by the second inflating system and providing for the inflation of the volume 6 or of the chamber 6B of said wing effects an ascending vertical path.

In this case, the motor-driven propeller (propeller 3 or jet engine) is positioned at the fuselage 18. Whenever this motor-driven propeller consists of a propeller 3, it is preferably installed in the front of said fuselage 18.

The motor-driven propeller thus installed is required to perform two simultaneous functions:
a propelling and thrust function permitting a translation flight, identical to that performed by the propelling device of conventional airplanes; and
a source of generation a pressurized gaseous fluid stream or flow used to inflate the closed inflation volume 6 of the wing 2, or the lower inflation chamber 6B, delimited by the upper cloth 4 and the lower cloth 5, or by the lower cloth 5 and separating cloth 7, respectively.

A gaseous fluid inlet port 35 is installed close to and behind the propeller 3 (FIG. 4). This inlet port 35 whose function is to catch part of the stream or flow of gaseous fluid generated by the operation of said propeller communicates with the closed inflation volume 6 or with the chamber 6B of the wing 2 through a conduit comprising for example, a semi-rigid gas line 14 connected to a tubular support column 19 that ends into said inflation volume 6 or into the chamber 6B after having run through the lower wing 5.

In the case where the support column 19 consists of a rigid shaft, the gas conduit 14 can carry the gaseous fluid directly into said inflation volume or into the chamber 6B after running through the lower cloth 5. This gas conduit can have a semi-rigid structure, and to that end be made of a cloth combined with rigid structural members that serve to give the desired form to the gas conduit.

It is understood that the air or other gaseous fluid caught by the inlet port 35 is then carried into the gas conduit 14, then in the support column 19 making up the rigid holding member before ending into the closed volume 6 or into the lower chamber 6B, ensuring the inflation of the wing permitting to give it the desired shape of airplane wing.

The air or other gaseous fluid conduit consisting of the line 14 and, possibly, of the support column 19, can be provided with openings (not shown), in its lowest section to permit discharge of the rain water or other liquid that might have entered into said conduit.

The inlet port 35 of the line 14-19 can have an adjustable section.

The outlet ports 33 judiciously distributed in the surface of the lower cloth 5 of the wing 2 allow for the discharge of excess air or other gaseous fluid blown into the inflatable volume 6 or into the inflatable chamber 6B, through the action of the motor-driven propeller 3.

According to this embodiment, the support column 19 performs two functions:
it constitutes a structural member used to attach the flexible wing 2 above and away from the fuselage 18; and
it provides, on part of its path, for circulation of the air or other gaseous fluid blown by the motor-driven propeller 3, up to the closed inflation volume 6 or up to the chamber 6B of the wing 2, based on the conformation of said wing.

Thus, according to this embodiment, part of the gas blast generated by the motor-driven propeller 3 is used to inflate the contoured wing 2 fixed above the fuselage 18. In this manner, the device thus configured is like an airplane with a very light wing. Compared to a conventional airplane (with rigid wings), its advantages include being might lighter, consuming less fuel, being easier to fabricate and therefore less costly, being much simpler to pilot (piloting close to that of a paraglider) and offering increased safety in case of accidents due to its capability to easily glide.

According to this embodiment, it is also preferable to use an inflatable wing 2 consisting of two inflation chambers 6A and 6B, in order to achieve maximum efficiency in the operation of the wing 2. However, for reasons of simplification and easy fabrication, the aircraft can also be designed with an inflatable wing 2 equipped with one single inflation volume 6, and provided with check valves 13, installed on the air inlet openings 12 distributed along the leading edge 9 as described above.

In order to avoid that the rotating components of the motor-driven propeller, such as a rotary propeller, accidentally come in contact with a component section of the inflatable wing 2 (such as suspension line or wing), a safety cage or net 36 can be arranged around these rotating components (FIG. 2).

In order to permit pivoting movements from the front to the back and vice versa of the support column 19, for example using the pivot type articulation described above, at least part of the connection 14a of conduit 14 for recovery and routing of the inflation gaseous fluid to the rigid support column or other rigid support spacing member 19, is made out of a flexible material allowing, on one hand, for angular movements of said spacing member in relation to said conduit 14 and, on the other hand, for a limited degree of freedom of the inflatable wing 2, especially vertically, in relation to the rigid holding member 19. For example, the ends of the conduit 14 made out of a rigid material and of the rigid holding member 19 can be connected through a flexible tubular coupling 14a. Likewise, a second flexible tubular coupling 14a can connect the rigid holding member 19 to the flexible wing 2 to give to the latter the capability of moving freely, especially with a vertical (upward and downward) movement in relation to the rigid holding member, but in a limited manner. The rigid support spacing member 19 must indeed rigidly connect the flexible wing 2 to the fuselage 18, while allowing for a limited freedom of movement, especially the vertical movement. The purpose of this limited freedom of movement of the flexible wing 2 in relation to the fuselage 18 and in relation to the rigid support spacing member 19 is to allow for optimum operation of the wing 2, it being reminded that said wing is connected to the fuselage 18 of the aircraft through the rigid support spacing member and through flexible holding members 20 of the suspension line or riser type. When in flight, the function of both types of attaching elements, namely the rigid support spacing member 19 and the suspension lines and risers is to receive and distribute the tractive forces associated with the weight of the aircraft to be withstood by the wing, these two attaching elements functioning in a synergic and complementary manner. The suspension lines 20 are indeed attached and distributed over the whole surface of the underside of the wing 2 and thus permit to advantageously distribute the tractive forces over the whole surface of the underside of said wing.

Thus, according to a characteristic arrangement of the invention, by choosing an embodiment under which the rigid holding element 19 offers a limited degree of freedom of movement between the flexible wing 2 and said rigid support spacing member 19, especially with regard to vertical movement, all suspension lines can operate efficiently in traction, when in flight. Moreover, still when in flight, the rigid support spacing member 19, being also connected to the wing 2, takes over part of all tractive forces. It is understood that the flexible wing 2, while being integral with the fuselage 18, holds a certain freedom of movement in relation to the latter due, on one hand, to the existence of the pivot type articulation 26 between the rigid support spacing member 19 and the fuselage 18, and, on the other hand, due to the specific link between said rigid support spacing member 19 and the wing 2 under which said wing has a limited capability to move in relation to said rigid support spacing member 19, especially in a direction parallel to the axis of said element, i.e., in practice, in the vertical direction.

FIG. 24 and mainly FIG. 25 show schematically an example of arrangement permitting to confer a limited amplitude freedom of movement of the wing 2 in relation to the top of the support column 19, especially in a direction parallel to the axis of the latter.

In order to carry out the specific link between the rigid holding element 19 and the wing 2 under which the latter hold a limited capability to move in relation to said rigid spacing member 19, the latter is equipped, at its upper part, with two superposed rings 37a et 37b inside which the secondary holding shaft 39 is inserted. The secondary holding shaft 39 acts as an intermediate link between the rigid spacing member 19 and the wing 2, and its presence contributes to achieving the limited freedom of movement between said rigid spacing member 19 and said wing 2. The secondary holding shaft 39 has two end stops 39a, 39b, the end stop 39a prevents it from going down through the rings 37a and 37b, while the end stop 39b keeps it integral with the upper part of the rigid spacing member 19, so that the secondary holding shaft 39 is integral with the rigid spacing member 19 and can move away from it only slightly by the positioning of the two superposed rings 37a, 37b, that are placed between the two end stops 39a, 39b. This arrangement thus makes it possible for the secondary support shaft 39 to be held integral above the rigid spacing member 19, while having a freedom of (upward and downward) movement in relation to said element.

This arrangement also enables the secondary shaft 39 supporting the wing 2 and, therefore the wing to have limited amplitude inclination movements in all directions in relation to the rigid spacing member 19.

In addition, the secondary holding shaft 39 is connected to the inflatable wing 2 through a pivot type articulation 38 with a longitudinal structural member 24, which structural member 24 is attached to the flexible wing 2.

This pivot articulation 38 is located in the middle section of the flexible wing 2, close to its leading edge 9. The system consisting of two rigid linking elements 19 and 39 and the special arrangement of the latter permit, on one hand, to maintain the wing 2 above and away from the fuselage 18 when the aircraft is on the ground, and on the other hand, to give to the inflatable wing 2 any freedom of movement necessary for its optimum operation when in flight.

It is understood that it is the length between the two stops 39a and 39b on one hand, and the length between the two rings 37a and 37b and the respective diameters of the latter, on the other hand, that define the freedom of (upward and downward) movement allowed to the wing 2 in relation to the rigid spacing member 19 as well as the limits of this freedom of movement. It should be noted that when the aircraft is idle on the ground, the suspension lines and risers 20 are also idle as they are not tightened by any tractive force: the flexible wing 2 is then supported solely by the rigid spacing member 19 that supports it completely through the secondary holding shaft 39.

In parallel, the presence of the support spacing member 19-39 of the flexible wing 2 gives it the capability of working in compression, which is not the case for paraglider wings that are attached solely by flexible elements of the suspension line and riser type.

The aircraft holds at least one attachment pint 21, fixed to the cockpit (fuselage or other as indicated above to receive the suspension lines and risers 20 and permit to attach and distribute the latter over a greater width and a more or less large attachment surface. In addition, the choice of materials to manufacture the attachment shafts 21 must ensure a gradual increase of the flexibility of the attachment shafts 21 as the attachment points of the suspension lines move away laterally from the fuselage, so that the wing 2 that is fixed to the attachment shafts 21 through the suspension lines and risers 20, shows a greater flexibility of ascending movement at its two lateral ends, which lateral ends of the wing 2 have then the capability of curving slightly toward the sky, especially when turning, which will improve accordingly the stability of the wing in the various flight phases. In other words, the attachment shaft 21 or each attachment shaft 21 provided with an elastic bending capability, has an increasing degree of flexibility in the direction of its or each of its free end(s) so as to thus feature an end or end portions 21a that are elastically deformable.

These inflatable wings 2A and 2B are offset relation to each other, vertically and longitudinally.

An air inlet port 35 is installed close to and behind the motor-driven propeller 3.

Part of the air or other gaseous fluid blown into the port 35 through the action of the motor-driven propeller 3 is carried to the inflation volume of the wing 2A through a conduit comprising for example a line 14A and a support column 19A connected to said line, and another part of the air or other gaseous fluid blown into said port is led to the inflation volume of the wing 2B through a conduit comprising for example a bypass 14B connected to the line 14A and a support column 19B connected to said bypass.

Still with the goal to increase the aircraft wing surface area, it is also possible to construct a biplane type aircraft comprising an inflatable wing 2A that can be deployed out and kept deployed by a stream or flow of air or other gaseous fluid blown from the top into the inflation volume of said wing, and an inflatable wing 2B that can be inflated and kept inflated by a stream or flow of air or other gaseous fluid blown from the bottom top into the inflation volume of said wing 2B. These two wings 2A, 2B can have a configuration identical to that of the various embodiments of the wing 2 described above and shown in the drawing figures; they are simply adapted in their middle section to the type of motor-driven propeller used to inflate them.

According to the embodiment example shown, the wing 2A is inflated using a method and device similar to those described above in relation to FIGS. 1 and 2 while the wing 2B is inflated using a method and device under which part of the air stream or flow generated by the operation of motor-driven propeller 3 is led to the air inlet opening of the second inflatable wing 2B through a conduit comprising for example a line 14C in which the inlet port 35A is placed close to and below the motor-driven propeller 3 and a support column 19C connecting the fuselage 18 and said second inflatable wing to which said line is connected.

The applications of the method and of the aircraft under the invention are numerous and varied.

This aircraft can constitute a new means of air transportation for persons and/or goods using natural winds. In addition, it can also:
be made in the form of remote-piloted airplanes (for example, for the transport of goods), which permits to eliminate the risks of bodily injury with a reduced transport cost;
be designed to constitute a surveillance drone;
find applications in the fields of aerospace activities, for example: satellite transport;
be applied in the field of aircraft modeling; and
find various applications in the recreation field.

1-30. (canceled)

31. Multi-purpose aircraft comprising:
a cockpit equipped with a motor-driven propeller ensuring displacement of the aircraft through air; and
an inflatable flexible wing of the paraglider type, said inflatable flexible wing being attached to said cockpit through flexible load suspension lines, said wing comprising an upper cloth or flexible wall of an upper wing surface and a lower cloth or flexible wall of an underwing, said upper cloth and said lower cloth defining an inflatable volume together and defining a front or leading edge and a rear or trailing edge when deployed,
wherein said inflatable flexible wing is connected to said cockpit through a rigid support spacing element, said at least one rigid spacing element being comprised of a tubular column or a rigid mast, the inflatable wing being maintained above and away from said cockpit,
wherein said inflatable flexible wing stays above and in place in relation to said cockpit and does not collapse when said load suspension lines are no longer taught during flight, and
wherein said inflatable flexible wing is positioned in advance above said cockpit in a position ready to be deployed and then to take off upon a take-off phase on the ground.

32. Multi-purpose aircraft according to claim 31, wherein said rigid spacing element is connected to a chassis or a fuselage through an articulation enabling said rigid spacing element to pivot from front to back and vice versa, said rigid spacing element having adjustable stops limiting amplitude of pivoting.

33. Multi-purpose aircraft according to claim 31, wherein said rigid spacing element is attached to the inflatable wing through means for a limited amplitude movement of the inflatable wing in relation to a top of said rigid spacing element, in a direction parallel to the axis of the inflatable wing.

34. Multi-purpose aircraft according to claim 31, wherein said rigid spacing element is connected to the inflatable wing through a secondary shaft and means for a limited amplitude inclination movement of said secondary shaft and, therefore, the inflatable wing, in all directions in relation to said rigid spacing element.

35. Multi-purpose aircraft according to claim 31, wherein said fuselage is equipped with at least one shaft for attaching suspension lines and risers.

36. Multi-purpose aircraft according to claim 35, wherein said attachment shaft is provided with an elastic bending capability and has an increasing degree of flexibility in a direction of a free end thereof, an end being elastically deformable.

37. Multi-purpose aircraft according to claim 31, wherein said adjustable stops have an adjustable position for pivoting amplitude of said rigid spacing element.

38. Multi-purpose aircraft according to claim 31 and allowing for the function, concurrently or successively, of two separate inflating systems, the aircraft further comprising:
a first inflating system being comprised of a device or arrangement enabling insufflation of a pressurized gas into said inflatable volume; and
a second inflating system being comprised of a device with air inlet openings distributed along said leading edge, said air inlet openings ending into said inflatable volume, admission of air into the inflatable volume being enabled when in flight and when inside pressure in said inflatable volume is lower than outside pressure, said air inlet openings being equipped with check valves when inflation air is admitted into an entirety of said inflatable volume.

39. Multipurpose aircraft according to claim 30, wherein said inflation volume comprises a first inflation chamber and a second inflation chamber, the inflation chambers being superposed and separated by a cloth or intermediate flexible wall, inflation of said first inflation chamber achieved by admission of air through said air inlet openings distributed along said leading edge of the inflatable wing, and inflation of said second chamber achieved using a pressurized gas, inflation of said inflation volume or said second inflation chamber achieved through insufflation of one of a group consisting of a compressed gas contained in a cylinder or tank, a compressed air supplied by a compressor and a stream or flow of gaseous fluid blown by said motor-driven propeller

40. Multi-purpose aircraft according to claim 39, wherein said motor-driven propeller comprises:
a propeller effecting translation displacement and being driven in rotation by a heat engine, an electric engine, turboshaft engine, turboprop engine, jet engine or turbojet engine, located at the cockpit; and
a conduit being provided with an inlet port placed close to and behind said motor-driven propeller and having an end running through the lower cloth of the inflatable wing and ending into the second inflation volume, ensuring recovery of part of ascending gaseous fluid stream or flow blown by said motor-driven propeller and insufflation thereof into said inflation volume.

41. Multi-purpose aircraft according to claim 40, further comprising:
a spar installed lengthwise close to the leading edge of the inflatable wing.

42. Multi-purpose aircraft according to claim 39, wherein said motor-driven propeller is comprised of a propeller ensuring ascending and descending displacement and is placed in a suction port running through the upper cloth and the separating cloth of the inflatable wing and ending into the second inflation chamber of the inflatable wing, the lower cloth of the inflatable wing defining said second inflation chamber, provided in a center section thereof with an opening placed below said propeller to allow for discharge downward of part of the air blast that is not blown into the second inflation chamber.

43. Multi-purpose aircraft according to claim 42, further comprising:
a retractable flexible flap or cloth attached on the lower cloth of the inflatable wing close to a central opening said central opening being closable when in gliding flight.

44. Multi-purpose aircraft according to claim 42, wherein said motor-driven propeller is driven in rotation by an engine installed at a fuselage, said engine being coupled to said motor-driven propeller through a drive shaft housed in a tubular column connecting the inflatable wing and the cockpit.
